(19) United States
(12) Patent Application Publication
(10) Pub. No.: US 2018/0267545 A1
(43) Pub. Date: Sep. 20, 2018

(54) MOBILE BODY POSITION ESTIMATION SYSTEM, APPARATUS, AND METHOD

(71) Applicant: Kabushiki Kaisha Toshiba, Tokyo (JP)

(72) Inventor: Tatsuhiko GOTO, Kawasaki (JP)

(73) Assignee: Kabushiki Kaisha Toshiba, Tokyo (JP)

(21) Appl. No.: 15/691,684

(22) Filed: Aug. 30, 2017

(30) Foreign Application Priority Data
Mar. 17, 2017 (JP) 2017-053418

(51) Int. Cl. G05D 1/02; G01S 5/18; G01S 11/12

(52) U.S. Cl. CPC G05D 1/0212; G01S 5/18; G01S 11/12; G01C 21/206; G05D 1/0255; G05D 1/027; G05D 1/0231

(57) ABSTRACT

According to one embodiment, a mobile body position estimation system includes an energy source, a mobile body, a plurality of physical quantity, and a processor. The energy source generates energy whose physical quantity changes. The mobile body is a position estimation target. The plurality of physical quantity detectors are provided in the mobile body. The plurality of physical quantity detectors detect the physical quantity of the energy generated from the energy source. The processor estimates a position of the mobile body based on a position of the energy source, an attitude angle of the energy source, and a plurality of physical quantity values respectively detected by the plurality of physical quantity detectors.

### CROSS-REFERENCE TO RELATED APPLICATIONS

This application is based upon, and claims the benefit of priority from the prior Japanese Patent Application No. 2017-053418, filed Mar. 11, 2017 the entire contents of which are incorporated herein by reference.

### FIELD

Embodiments described herein relate generally to a mobile body position estimation system, apparatus, and method.

### BACKGROUND

In mobile body indoor position estimation, a positioning technique using a Wi-Fi radio field intensity, indoor GPS signal, or ultrasonic sensor, a position recognition technique using a camera, RFID, marker, or the like, and a technique using dead reckoning utilizing internal sensors have been examined. In an estimation technique using ultrasonic waves, whose indoor position estimation accuracy is currently highest, it is necessary to install ultrasonic sensors at an. interval of 1 to 2 m on a ceiling or the like, and work is required to attach such ultrasonic sensors to an existing construction structure, which costs much. Using the Wi-Fi radio filed intensity or indoor GPS signal reduces the installation cost, as compared with the above technique, but the position estimation accuracy degrades due to the influence of the indoor multipath of radio waves.

### BRIEF DESCRIPTION OF THE DRAWINGS

FIG. 1 is a block diagram showing the configuration of a mobile body position estimation system according to an embodiment;

FIG. 2 is a view showing the attitude angle of an energy source shown in FIG. 1;

FIG. 3 is a view showing an outline of an operation example of the mobile body position estimation system shown in FIG. 1;

FIG. 4 is a flowchart illustrating the typical procedure associated with mobile body position estimation performed under the control of a processor shown in FIG. 1;

FIG. 5 is a view showing schematically showing the first simulation conditions according to this embodiment;

FIG. 6A, FIG. 6B, FIG. 6C and FIG. 6D show views of the simulation result of the estimated trajectory of a two-wheel truck, which is obtained by executing position estimation processing according to the embodiment under the first simulation conditions;

FIG. 7A, FIG. 7B, FIG. 7C and FIG. 7D show views of the simulation result of the estimation error of the two-wheel truck, which is obtained by executing the position estimation processing according to the embodiment under the first simulation conditions of FIG. 6A, FIG. 6B, FIG. 6C and FIG. 6D;

FIG. 8 is a timing chart showing the time-series transitions of diagonal components x, y, ψ, and r of a posterior error covariance matrix ps, which are obtained by executing the position estimation processing according to the embodiment under the first simulation conditions of FIG. 6A, FIG. 6B, FIG. 6C and FIG. 6D;

FIG. 9A is a view showing the actual measurement values of respective illuminance sensors 41-n (n=1 to 5), which are obtained by executing the position estimation processing according to the embodiment under the first simulation conditions of FIG. 6A, FIG. 6B, FIG. 6c and FIG. 6D;

FIG. 9B is a view showing the estimation values of respective illuminance sensors 41n (n=1 to 5), which are obtained by executing the position estimation processing according to the embodiment under the first simulation conditions of FIG. 6A, FIG. 6B, FIG. 6c and FIG. 6D;

FIG. 10 is a view showing the estimation result of odometry, which is obtained by executing the position estimation processing according to the embodiment under the first simulation conditions of FIG. 6A, FIG. 6B, FIG. 6c and FIG. 6D;

FIG. 11A, FIG. 11B, FIG. 11C and FIG. 11D show views of the simulation result of the estimated trajectory of a two-wheel truck, which is obtained by executing the position estimation processing according to the embodiment under the second simulation conditions;

FIG. 12A, FIG. 12B, FIG. 12C and FIG. 12D show views of the simulation result of the estimation error of the two-wheel truck, which is obtained by executing the position estimation processing according to the embodiment under the second simulation conditions of FIG. 11A, FIG. 11B, FIG. 11c and FIG. 11D;

FIG. 13A is a view showing the actual measurement values of the respective illuminance sensors, which are obtained by executing the position estimation processing according to the embodiment under the second simulation conditions of FIG. 11A, FIG. 11B, FIG. 11C and FIG. 11D;

FIG. 13B is a view showing the estimation values of the respective illuminance sensors, which are obtained by executing the position estimation processing according to the embodiment under the second simulation conditions of FIG. 11A, FIG. 11B, FIG. 11c and FIG. 11D;

FIG. 14 is a view showing the estimation result of the trajectory of a mobile body when the attitude angle of an energy source is desirably fixed in a vertically downward direction under the second simulation conditions of FIG. 11A, FIG. 11B, FIG. 11C and FIG. 11D;

FIG. 15A is a view showing the true actual measurement values of the respective illuminance sensors under the second simulation conditions of FIG. 14;

FIG. 15B is a view showing the estimation values of the respective illuminance sensors under the second simulation conditions of FIG. 14;

FIG. 16 is a view schematically showing a light source to which spectral films are adhered;

FIG. 17 is a view schematically showing the light distribution of light emitted from the light source of FIG. 16 to which the spectral films are adhered;

FIG. 18 is a view schematically showing the light source to which the spectral films are adhered in a forts different from that shorn in FIG. 16;

FIG. 19 is a view showing the arrangement of two energy sources according to the embodiment;

FIG. 20 is a view showing a sound pressure distribution generated from a parametric loudspeaker of an output frequency of 1 kHz in consideration of an end-fire array;

FIG. 21A, FIG. 21B, FIG. 21C and FIG. 21D show views of the simulation result of the estimated trajectory of the two-wheel truck, which is obtained by executing the position estimation processing according to the embodiment under the third simulation conditions;

FIG. 22A, FIG. 22B and FIG. 22C show views of the simulation result of the estimation error of the two-wheel truck, which is obtained by executing the position estimation processing according to the embodiment under the third simulation conditions of FIG. 21A, FIG. 21B, FIG. 21C and FIG. 21D;

FIG. 23A is a view showing the time transitions of the pan angles and tilt angles of respective parametric loudspeakers, which are obtained by executing the position estimation processing according to the embodiment under the third simulation conditions of FIG. 21A, FIG. 21B, FIG. 21C and FIG. 21D;

FIG. 23B is a view showing the time transitions of the pan angles and tilt angles of respective parametric loudspeakers; which are obtained by executing the position estimation processing according to the embodiment wider the third simulation conditions of FIG. 21A, FIG. 21B, FIG. 21C and FIG. 21D;

FIG. 24A is a view showing the actual measurement values of the respective illuminance sensors under the third simulation conditions of FIG. 21A, FIG. 21B, FIG. 21C and FIG. 21D;

FIG. 24B is a view showing the estimation values of the respective illuminance sensors under the third simulation conditions of FIG. 21A, FIG. 21B, FIG. 21C and FIG. 21D;

FIG. 25A, FIG. 25B, FIG. 25C and FIG. 25D show views of the simulation result of the estimated trajectory of the two-wheel truck, which is obtained by executing the position estimation processing according to the embodiment under the fourth simulation conditions;

FIG. 26A, FIG. 26B and FIG. 26C show views of the simulation result of the estimation error of the two-wheel truck, which is obtained by executing the position estimation processing according to the embodiment under the fourth simulation conditions of FIG. 25A, FIG. 25B, FIG. 25C and FIG. 25D;

FIG. 27A is a view showing the actual measurement values of the respective illuminance sensors under the fourth simulation conditions of FIG. 25A, FIG. 25B, FIG. 25C and FIG. 25D; and

FIG. 27B is a view showing the estimation values of the respective illuminance sensors under the fourth simulation conditions of FIG. 25A, FIG. 25B, FIG. 25C and FIG. 25D.

### DETAILED DESCRIPTION

A position estimation system according to an embodiment includes an energy source, a mobile body, a plurality of physical quantity detectors, and a processor. The energy source generates energy whose physical quantity changes. The mobile body is a position estimation target. Each of the plurality of physical quantity detectors is provided in the mobile body, and detects the physical quantity of the energy generated by the energy source. The processor estimates the position of the mobile body based on the position of the energy source, the attitude angle of the energy source, and a plurality of physical quantity values detected by the plurality of physical quantity detectors.

A mobile body position estimation system, apparatus, and method according to this embodiment will be described below with reference to the accompanying drawings.

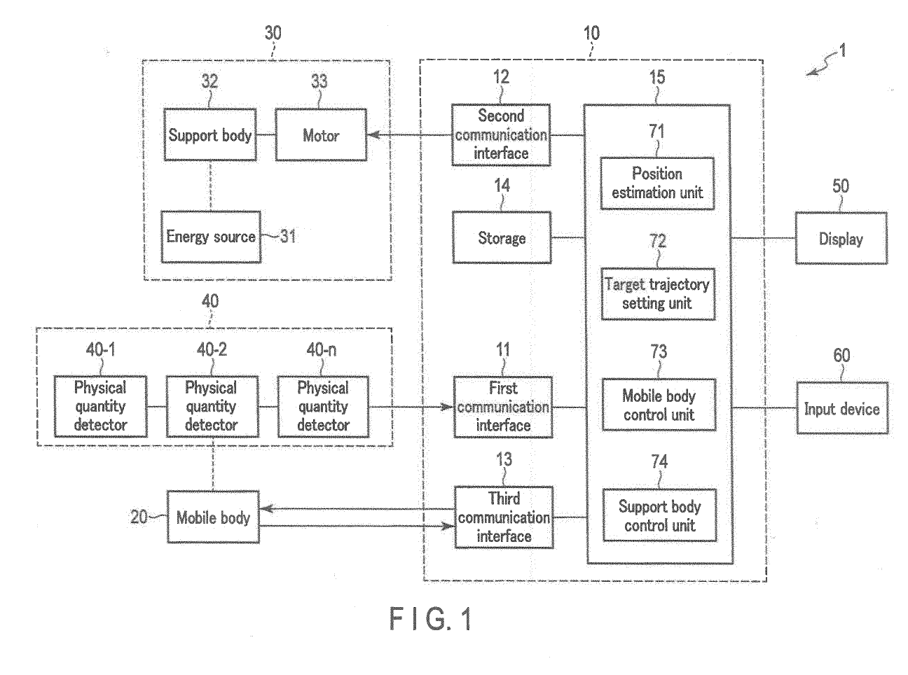

FIG. 1 is a block diagram showing the configuration of a mobile body position estimation system 1 according to the embodiment. As shown in FIG. 1, the mobile body position estimation system 1 includes a mobile body position estimation apparatus 10, a mobile body 20, an energy irradiator 30, a physical quantity detection unit 40, a display 50, and an input device 60. The mobile body position estimation system 1 causes the mobile body position estimation apparatus 10 to estimate the position of the mobile body 20 moving indoors based on the spatially distributed physical quantity of energy emitted from the energy irradiator 30 and detected by the physical quantity detection unit 40.

The mobile body 20 is an apparatus moving indoors. As the mobile body 20, a vehicle traveling on an indoor floor surface, wall, or the like, a body flying in an indoor space, or a robot walking on a floor surface or the like is appropriately usable. The mobile body 20 is communicably connected to the mobile body position estimation apparatus 10. The mobile body 20 incorporates a prime mover such as a motor or engine. The mobile body 20 moves by driving-respective movable shafts by the power of the prime mover in accordance with a movement command from the mobile body position estimation apparatus 10. The mobile body 20 is provided with internal sensors. Encoders attached to the movable shafts of the mobile body 20 and an azimuth sensor attached to an arbitrary position of the mobile body 20 are appropriately selected as the Internal sensors. Each encoder outputs a signal indicating the rotation angle of the movable shaft. The azimuth sensor detects the azimuth of the mobile body 20, and outputs a signal indicating an output value (azimuth detection value) representing the azimuth. As the azimuth sensor, for example, an acceleration sensor or gyro sensor is preferably used. The acceleration sensor detects the acceleration of the mobile body 20, and outputs a signal indicating acceleration detection. The gyro sensor detects the angular velocity of the mobile body 20, and outputs a signal indicating angular velocity detection. The pieces of output information (to be referred to as internal sensor information hereinafter) of these external sensors are transmitted to the mobile body position estimation apparatus 10.

The energy irradiator 30 emits energy having a distributed physical quantity in an arbitrary direction. More specifically, the energy irradiator 30 includes an energy source 31, a support body 32, and a motor 33. The energy source 31 generates energy having a distributed physical quantity. The energy having the distributed physical, quantity indicates energy having a physical quantity which changes in accordance with the propagation distance and directivity from the energy source 31. Examples of the energy source 31 are a light source for generating light, and a sound source having a sound. The directivity of light is represented by a light distribution indicating the spatial distribution of the physical quantity such as an illuminance. Note that a sound wave according to this embodiment may be an audible sound or ultrasonic wave. The directivity of the sound is represented by a sound pressure distribution indicating the spatial distribution of the physical quantity such as a sound pressure. The energy emitted from the energy irradiator 30 is used as external information for position estimation of the mobile body 20.

The support body 32 variably supports the attitude angle of the energy source 31. The support body 32 includes a predetermined rotation shaft for adjusting the attitude angle, a bearing which rotatably supports the rotation shaft, and a frame which structurally supports the bearing,

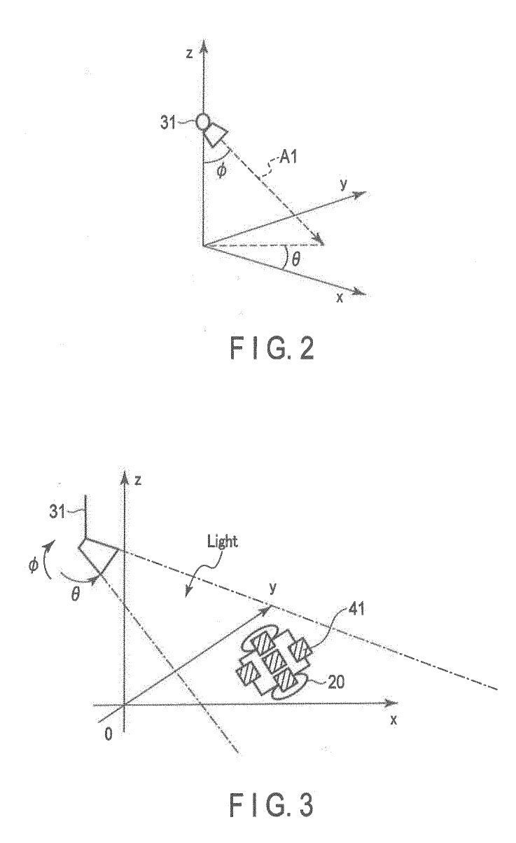

FIG. 2 is a view showing the attitude angle of the energy source 31 according to this embodiment. As shown in FIG. 2, the energy source 31 is attached to an indoor ceiling, wall surface, or structure via the support body 32 (not shown). In this embodiment, a z-axis is defined in the vertical direction, a y-axis is horizontally orthogonal to the z-axis, and an x-axis is orthogonal to the z- and y-axes. The x-, y-, and z-axes form a three-axis orthogonal coordinate system. Examples of the variable attitude angle according to this embodiment are a tilt angle Φ and a pan angle θ. As the tilt angle ϕ, for example, an angle from the z-axis to a central axis A1 of the energy emitted by the energy source 31 is defined. As the pan angle θ, for example, an angle from the x-axis to the central axis A1 on an xy plane is defined.

The motor 33 drives the support body 32 in accordance with an angle change command from the mobile body position estimation apparatus 10 to change the attitude angle of the energy source 31, that is, the tilt angle and pan angle. For example; the motor 33 changes the attitude angle of the energy source 31 so as to emit energy to the estimated position of the mobile body 20. As the motor 33, for example, an arbitrary motor such as a servo motor is used. Note that a motor for the tilt angle and a motor for the pan angle may be provided as the motor 33.

The physical quantity detection unit 40 is attached to the mobile body 20. The physical quantity detection unit 40 detects the spatial distribution of the physical quantity of the energy emitted from the energy irradiator 30. The physical quantity detection unit 40 includes a plurality of physical quantity detectors 41-n (n is an integer representing the number of physical quantity detectors) each for detecting the physical quantity. The plurality of physical quantity detectors 41-n are provided in the mobile body 20. The number of physical quantity detectors 41-n may be arbitrary as long as the number is three or more. Each physical quantity detector 41-n detects the physical quantity of the energy emitted from the energy irradiator 30, and outputs a data signal having a digital value corresponding to the detected physical quantity. The digital value corresponding to the detected physical quantity will be referred to as a physical quantity value hereinafter, and the data signal having the physical quantity value will be referred to as physical quantity detection information hereinafter.

The physical quantity detection information is supplied to the mobile body position estimation apparatus 10. For example, if the energy source 31 is a light source, an illuminance sensor for detecting an illuminance as the physical quantity of light is preferably used as a physical quantity detector 41-1. For example, if the energy source 31 is a sound source, a microphone for detecting a sound pressure as the physical quantity of a sound is preferably used as the physical quantity detector 41-1.

The mobile body position estimation apparatus 10 estimates the position of the mobile body 20 moving indoors based on the distributed physical quantity of the energy emitted from the energy irradiator 30 and detected by the physical quantity detection unit 40. The mobile body position estimation apparatus 10 includes, as hardware; a first communication interface 11, a second communication interface 12, a third communication interface 13, a storage 14, and a processor 15. The first communication interface 11, the second communication interface 12, the third communication interface 13, and the storage 14 are connected to the processor 15 via a bus.

The first communication interface 11 is an interface used for communication with the physical quantity detection unit 40. For example, the first communication interface 11 receives physical quantity detection information about the physical quantity values transmitted from the physical quantity detection unit 40. The received physical quantity detection information is transferred to the processor 15.

The second communication interface 12 is an interface used for communication with the energy irradiator 30. For example, the second communication interface 12 transmits, to the energy irradiator 30, the angle change command output from the processor 15. More specifically, the angle change command includes an angle change command related to the pan angle and that related to the tilt angle.

The third communication interface 13 is an interface used for communication with the mobile body 20. For example, the third communication interface 13 transmits, to the mobile body 20, the movement command output from the processor 15. The movement command includes information about the advancing direction and. distance of the mobile body. The third communication interface 13 also receives the internal sensor information from the mobile body 20. The received internal sensor information is transferred to the processor 15.

Note that the first communication interface 11 for the physical quantity detection unit 40, the second communication interface 12 for the energy irradiator 30, and the third communication interface 13 for the mobile body 20 are provided. However, one or two communication interfaces may be used to communicate with the physical quantity detection unit 40, energy irradiator 30, and mobile body 20. Furthermore, a communication interface may be provided for communication with the internal sensors and the like provided in the mobile body 20.

The storage 14 includes a ROM (Read Only Memory), an HDD (Hard Disk Drive), an SSD (Solid State Drive), and an integrated circuit memory. The storage 14 stores, for example, the pieces of information received by the communication interfaces 11, 12, and 13, various processing results of the processor 15, and various programs to be executed by the processor 15.

The processor 15 includes a CPU (Central Processing Unit) and a RAM (Random Access Memory), The processor 15 implements a position estimation unit 71, a target trajectory setting unit 72, a mobile body control unit 73, and a support body control unit 74 by executing the programs stored in the storage 14.

The position estimation unit 71 repeatedly estimates the position of the mobile body 20 based on the position of the energy source 31, the attitude angle of the energy source 31, and the plurality of physical quantity values respectively detected by the plurality of physical quantity detectors 40-n. For position estimation, at least one algorithm among a Kalman filter, extended Kalman filter, unscented Kalman filter, particle filter, and the like is used. Note that the position estimation unit 71 may perform position estimation in consideration of other information such as the internal sensor information to improve the estimation accuracy. The position estimation unit 71 may estimate the position of the mobile body 20 using at least one algorithm among the Kalman filter, extended Kalman filter, unscented Kalman filter, and particle filter based on the movement model of the mobile body 20 and at least one of the pieces of internal sensor information of the rotation angle, acceleration, and angular velocity of the mobile body 20 detected by the internal sensors in addition to the position of the energy source 31, the attitude angle of the energy source 31, and the plurality of physical quantity by values.

The target trajectory setting unit 72 sets the target trajectory of the mobile body 20 in accordance with an instruction by the input device 60. Note that the target trajectory setting unit 72 may set, as the target trajectory, a trajectory preset by another computer.

The mobile body control unit 73 controls the mobile body 20 to move along the target trajectory set by the target trajectory setting unit 72. More specifically, the mobile body control unit 73 calculates a deviation of the estimated position of the mobile body 20 from the target trajectory, calculates the driving amounts of the respective movable shafts of the mobile body 20 to correct the deviation, and generates a movement command in accordance with the driving amounts of the respective movable shafts.

The support body control unit 74 controls the attitude angle of the energy source 31 so that the energy source 31 emits energy toward the position of the mobile body 20 estimated by the position estimation unit 71. More specifically, the support body control unit 74 calculates the target attitude angle of the energy source 31 to emit energy toward the estimated position of the mobile body 20, calculates the driving amounts of the respective movable shafts of the support body 32 to change the current attitude angle to the target attitude angle, and generates an angle change command in accordance with the driving amounts of the respective movable shafts.

Note that the position estimation unit 71, the target trajectory setting unit 72, the mobile body control unit 73, and the support body control unit 74 may be implemented by a single CPU, or may be distributed to a plurality of CPUs and implemented.

As shown in FIG. 1, the display 50 and the input device 60 are connected to the mobile body position estimation apparatus 10. The display SO displays various kinds of information for the position estimated by the processor 15, As the display 50, for example, a CRT (Cathode-Say Tube) display, a liquid crystal distal, an organic EL (Electro Luminescence) display, an LED (Light-Emitting Diode) display, a plasma display, or another arbitrary display known in the technical field can appropriately be used.

The input device 60 receives various commando from the user. More specifically, a keyboard and mouse, various switches, a touch pad, a touch panel display, and the like can appropriately be selected as the input device 60. An output signal from the input device 60 is supplied to the processor 15. Note that a computer connected to the processor 15 via a wire or wirelessly may be used as the input device 60.

The mobile body position estimation apparatus 10 may be provided in any location. For example, the mobile body position estimation apparatus 10 may be incorporated in a computer or the like provided outside or inside a building where the mobile body 20 moves, or provided in the mobile body 20, the energy irradiator 30, or the like. Furthermore, the position estimation unit 71, the target trajectory setting unit 72, the mobile body control unit 73, and the support body control unit 74 need not be implemented in the same apparatus, and may be distributed and implemented in the computer provided outside or inside the building, the mobile body 20, the energy irradiator 30, and the like.

An operation example of the mobile body position estimation system 1 according to this embodiment will be described in detail next. FIG. 3 is a view showing an outline of the operation example of the mobile body position estimation system 1 according to this embodiment. As shown in FIG. 3, in the following operation example, a two-wheel truck is used as the mobile body 20, a light source is used as the energy irradiator 30, and illuminance sensors are used as the physical quantity detectors 41-n,

A practical example of position estimation of the two-wheel truck 20 by the position estimation unit 71 of the processor 15 will be described in detail below. As a system equation which describes the movement model of the two-wheel truck 20, geometric relational equations (1), (2), and (3) below which take no dynamics into consideration are used with reference to non-patent literature 1.

$$\begin{matrix}X ( k + 1 ) = f ( X ( b ) , u ( k ) ) = X ( k ) + [ \begin{matrix}- AB sin ( ψ ( k ) ) \text{/} ( 4 d ) + A cos ( ψ ( k ) ) \text{/} 2 \\ AB cos ( ψ ( k ) ) \text{/} ( 4 d ) + A sin ( ψ ( k ) ) \text{/} 2 \\ B \text{/} d \\ 0\end{matrix} ] & ( 1 ) \\ {X}^{T} ( k ) = [ x ( k ) , y ( k ) , ψ ( k ) , r ( k ) ] & ( 2 ) \\ {u}^{T} ( k ) = [ {u}_{r} ( k ) , {u}_{l} ( k ) ] & ( 3 )\end{matrix}$$

where X(k) represents a state vector indicating the position of the two-wheel truck 20 at time k, and is formed from four state variables x(k), y(k), Φ(k), and r(k), as indicated by equation (2). x(k) represents the X-coordinate position of the two-wheel truck 20 at time k, y(k) represents the coordinate position of the two-wheel truck 20 at time k, Φ(k) represents the attitude of the two-wheel truck 20 at time k, and r(k) represents the wheel radius of the two-wheel truck 20 at time k. As indicated by equation (1), the state vector X(k+1) representing the position of the two-wheel truck 20 at time k+1 is expressed by a function of the state vector X(k) and an observation model u(k). (k) represents an encoder change amount at the sampling interval of the wheels of the two-wheel truck 20 at time k. As indicated by equation (3), u(k) is formed by uᵣ(k) representing an encoder change amount at the sampling interval of the right wheel of the two-wheal truck 20 at time k and u₁(k) representing an encoder change amount at the sampling interval of the left wheel of the two-wheel truck 20 at time k. Note that since the two-wheel truck 20 is used, it is assumed that the two-wheel truck 20 moves on the xv plane with z=0 without considering the height.

In equation (1), A is defined by A=(u₁+uᵣ)r, and B is defined by B=(u₁−uᵣr)r. Furthermore, d represents the width of the wheels, T represents transposition, and uᵣ(k) and u₁(k) are input to the above system equation. Note that the system equation may incorporate the azimuth detection values such as the acceleration and angular velocity of the mobile body 20 detected by the azimuth sensor. This further improves the position estimation accuracy of the mobile body 20.

The position estimation processing is divided into a prediction step and a filtering step. In the prediction step, the state vector X(k+1) at time k+1 is calculated based on the state vector X(k) at time k and system noise. The system noise is an encoder measurement error, and is given as a triangular distribution having an encoder resolution as a contact point, thereby obtaining a true trajectory. In the prediction step at the time of position estimation, the noise term cannot be separated, and thus not the unscented Kalman filter (UKF) but the extended Kalman filter (EKF) is used.

Furthermore, in the prediction step, a matrix F(k) is calculated by partially differentiating the function f of equation (1) by the state vector X, given by equation (4) below, and a matrix G(k) is calculated by partially differentiating the function f by the observation model u, given by equation (5) below,

$$\begin{matrix}F ( k ) = \frac{\partial f}{\partial X} {\vert}_{X = {X}_{e} ( k ) , v = u ( k )} & ( 4 ) \\ G ( k ) = \frac{\partial f}{\partial u} {\vert}_{X = {X}_{e} ( k ) , u = v ( k )} & ( 5 )\end{matrix}$$

In equations (4) and (5), Xₛ(k) represents a posterior state estimation value at time k. A prior state estimation value Xₚ(k+1) at time k+1 is calculated based on the posterior state estimation value and observation model u(k) at time k, given by equation (6) below. A prior error covariance matrix Pₚ(k+1) at time k+1 is calculated based on the matrix F(k), posterior error covariance matrix Pₛ(k), matrix G(k), and system noise covariance matrix Q at time k, given by equation (7) below. The system noise covariance matrix Q is obtained by approximating the triangular distribution, noise of the encoder by a Gaussian distribution, given by equation (8) below, co represents the number of pulses per revolution of the encoder.

$$\begin{matrix}{X}_{y} ( k + 1 ) = f ( {X}_{s} ( k ) , u ( k ) ) & ( 6 ) \\ {P}_{v} ( k + 1 ) = F ( k ) {P}_{s} ( k ) {F}^{T} ( k ) + G ( k ) {QG}^{T} ( k ) & ( 7 ) \\ Q = [ \begin{matrix}{( 2 π \text{/} co )}^{2} & 0 \\ 0 & {( 2 π \text{/} co )}^{2}\end{matrix} ] & ( 8 )\end{matrix}$$

The prediction step according to this embodiment has been explained above. The observation value of the illuminance sensor 41 will be described. Assume that the arrangement position of each illuminance sensor 41 in an object coordinate system having the center of the two-wheel truck 20 as an origin is represented by sᵢ where i indicates the number of the illuminance sensor 41. Based on the geometric relationship between the light source 31, the two-wheel truck 20, and each illuminance sensor 41 in a world coordinate system, a vector rᵢ(k) from a position Lₓ of the light source 31 to the arrangement position sᵢ at time k is given by equation (9) below.

$${r}_{i} ( k ) = [ \begin{matrix}cos ( ψ ( k ) ) & - sin ( ψ ( k ) ) & 0 \\ sin ( ψ ( k ) ) & cos ( ψ ( k ) ) & 0 \\ 0 & 0 & 1\end{matrix} ] {s}_{i} + [ \begin{matrix}x ( k ) \\ y ( k ) \\ 0\end{matrix} ] - {L}_{x} \qquad ( 9 )$$

Based on the pan angle θ and the tilt angle ϕ, a line-of-sight vector Lₐ of the light source 31 is given by equation (10) below.

Lₛ=[OOS(ϕ)cos(θ), OOS(ϕ) sin(74 ), sin(ϕ)]^{T} (10)

An angle θₐᵢ formed, by the line-of-sight vector Lₐ of the light source 31 and the position vector rᵢ of each illuminance sensor 41 is given by equation (11) below.

θₐₛ=cos⁻³(Lₐ.rᵢ/|rᵢ|) (11)

If the light distribution of the light source 31 is determined by a function I(θₐᵢ(k)), an observation value s1ᵢ(k) of each illuminance sensor 41 at time k is given by equation (12) below. Where a represents (light velocity of light from light source 31)/(reference light velocity in light distribution), and n₁ represents observation noise. Assume that the observation noise n₁ is noise according to a standard, deviation σᵢ and a Gaussian distribution with mean 0.

$${sl}_{i} ( k ) = α \frac{l ( {θ}_{af} ( k ) )}{\vert {r}_{i} {\vert}^{2}} + {n}_{i} \qquad ( 12 )$$

Equation (12) above forms an observation equation related to the illuminance sensor 41, The observation equation indicated by equation (12) is represented by Z(k) given, by equation (13) below. That is, the observation equation Z(k) related to the illuminance sensor 41 is represented by the sum of the transposition of the observation noise nᵢ and an. observation function h(X(k)) with, as a variable, the state vector X(k) indicating the position of the two-wheel truck 20, which is related to the illuminance sensor 41. Note that, the number of illuminance sensors 41 is represented by m. The observation noise covariance matrix: R is given by equation (14) below,

Z(k)=h(X(k))+[n₁,...,nₘ]^{T}=[sl₁(k),...,slₘ(k)]^{T}+[n₁,...,nₘ]^{T} (13)

R=diag[σ₁²,...,σₘ²] (14)

The filtering step will be described next. As indicated by equations (12) and (13) above, the observation equation is nonlinear. It is, therefore, necessary to use the extended Kalman filter or unscented Kalman filter in the filtering step. Note that the relationship from the state to the actual measurement value is complicated, and it is thus difficult to apply the extended Kalman filter. Therefore, in the filtering step according to this embodiment, the unscented Kalman filter is used.

In the filtering step, filtering is performed using the unscented Kalman filter based on the prior state estimation value Xₚ(k) given by equation (6) and the observation equation Z(k) given by equation (13) to modify the prior state estimation value Xₚ(k), thereby estimating the posterior state estimation value Xₛ(k) at time k. Furthermore, filtering is performed using the unscented Kalman filter based on the prior error covariance matrix Pₚ(k) given by equation (6) and observation equation Z(k) given by equation (13) to modify the prior error covariance matrix Pₚ(k), thereby estimating the posterior error covariance matrix Pₛ(k) at time k.

More specifically, 2n+1 σ points of the prior state estimation value Xₚ(k) are created. The σ points include one average value and 2n standard deviations around the average value. A σ point Xₛ⁻ corresponding to the average value is given by equation (15) below, σ points X₁⁻ corresponding to the first to nth standard, deviations

are given by equation (16) below, σ points Xₙ₊₁⁻ corresponding to the (n+1)th to 2nth standard deviations are given by equation (17) below.

Xₒ⁻(k)=Xₚ(k) (15)

Xᵢ⁻(k)=Xₚ(k)+\sqrt{n+k}({square root over (Pₚ(k)))}_{i, (i=}1,2,...,n) (16)

Xₙ₊ᵢ⁻(k)=Xₚ(k)−\sqrt{n+k}(√Pₚ(k))ᵢ(i=1,2,...,n) (17)

where (\sqrt{Pₚ(k)}))₁ represents the ith column of a matrix \sqrt{Pₚ(k)}. Note that the number of state variables is four, as described above, and thus n=4 and σ=9. A variable k is an adjustment parameter.

The following description assumes that yᵢ⁻(k)=h(Xᵢ⁻(k)). yᵢ⁻(k)) represents the prior output estimation value of the physical quantity values (observation values) of the m illuminance sensors 41 for the ith σ point. The prior output estimation value y^{Λ-}(k) is calculated by unscented transformation based on yᵢ⁻(k) and a weight Wᵢ, given by equation (18) below.

$${\hat{y}}^{- 1} ( k ) = {\sum }_{l = 0}^{2 n} {W}_{l} {y}_{i}^{-} ( k ) \qquad ( 18 )$$

Similarly, a prior output error covariance matrix P_{yy}⁻(k) at time k is calculated by unscented transformation based on yᵢ⁻(k), the prior output estimation value V^{Λ-}(k), and the weight Wᵢ, given by equation (19) below.

$${P}_{yy}^{-} ( k ) = {\sum }_{i = 0}^{2 n} {W}_{i} ( {y}_{i}^{-} ( k ) - {\hat{y}}^{- 1} ( k ) ) {( {y}_{i}^{-} ( k ) - {\hat{y}}^{-} ( k ) )}^{T} \qquad ( 19 )$$

Furthermore, a prior state/output error covariance matrix P_{xy}³¹ (k) at time k is calculated by unscented transformation based on the σ point Xᵢ⁻, the prior state estimation value Xₚ(k), yᵢ⁻(k), the prior output estimation value y^{Λ-}(k), and the weight Wᵢ, given by equation (20) below.

$${P}_{xy}^{-} ( k ) = {\sum }_{i = 0}^{2 n} {W}_{i} ( {X}_{i}^{-} ( k ) - {X}_{p} ( k ) ) {( {y}_{i}^{-} ( k ) - {\hat{y}}^{-} ( k ) )}^{T} \qquad ( 20 )$$

Next, the Kalman gain G(k) is calculated based on the prior state/output error covariance matrix P_{xy}⁻(k), the prior output error covariance matrix P_{yy}⁻(k), and the observation noise covariance matrix R, given by equation (21) below.

G(k)=P_{zy}⁻(k)(P_{yy}⁻(k)+R)⁻¹ (21)

Then, the posterior state estimation value Xₛ(k) is calculated based on the prior state estimation value Xₚ(k), the Kalman gain G(k). the observation equation Z(k) related to the illuminance sensor 41, and the prior output estimation value y^{Λ-}(k), given by equation (22) below. The posterior state estimation value Xₛ(k) is output as the estimated position of the two-wheel truck 20 at time k. Furthermore, the posterior error covariance matrix Pₛ(k) is calculated based on the prior error covariance matrix Pₚ(k), the Kalman gain G(k), and the prior state/output: error covariance matrix (k), given by equation (23) below.

Xₛ(k)=Xₚ(k)+G(k)(Z(k)−ŷ³¹ (k)) (22)

Pₛ(k)=Pₚ(k)−G(k)(P_{xy}⁻(k))^{T} (23)

After the posterior state estimation value Xₛ(k) and the posterior error covariance matrix Pₛ(k) are calculated, the filtering step ends. The estimated position of the two-wheel truck 20 is updated by repeating the prediction step and the filtering step,

An example of position estimation of the two-wheel truck 20 by the position estimation unit 71 according to this embodiment has been explained.

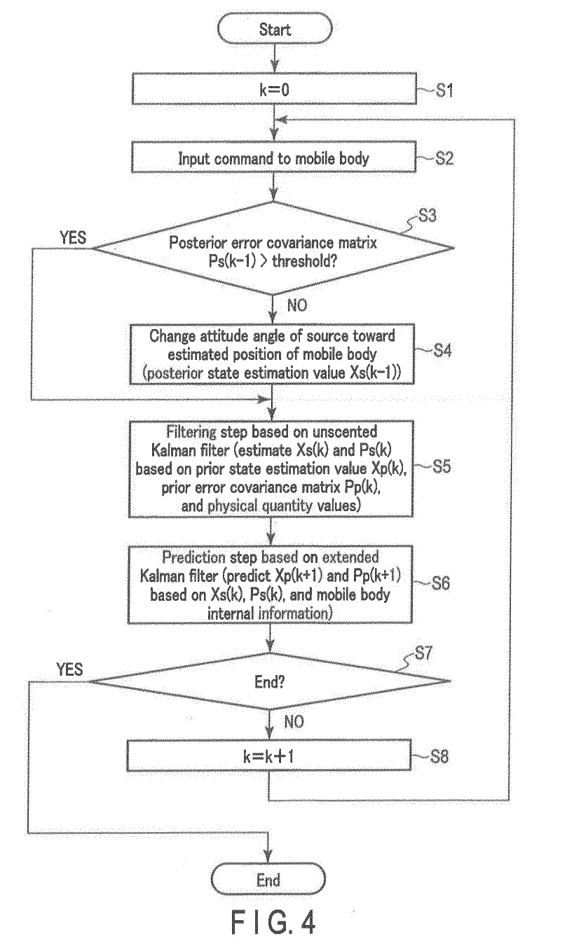

The procedure of position estimation processing by the mobile body position estimation system 1 according to this embodiment will be described next, FIG. 4 is a flowchart illustrating the typical procedure associated with position estimation, of the two-wheel truck 20 under the control of the processor 15 according to this embodiment.

As shown, in FIG. 4, the position estimation unit 71 of the processor 15 sets time k to an initial value of 0 (step S1).

After step S1 is performed, the mobile body control unit 73 of the processor 15 executes an input command to the two-wheel truck 20 (step S2). For the initial value k−0, the mobile body control unit 73 supplies a movement command based on the target trajectory set by the target trajectory Betting unit 72 to the mobile body (two-wheel truck) 20 via the third communication interface 13. The two-wheel truck 20 moves indoors in accordance with the movement command. While the two-wheel truck 20 moves, the illuminance sensor 41-n detects the illuminance of light generated by the light source 31, and supplies the detected illuminance value to the processor 15 via the first communication interface 11.

After step S2 is performed, the support body control unit 74 of the processor 15 performs step S3.

Note that if time k is set to the initial value k=0, no posterior error covariance matrix Pₛ(k−1) is calculated, and thus none of steps S3 and S4 are performed. That is, the attitude angle of the light source 31 is fixed to an initial angle.

In step S5, the position estimation unit 71 of the processor 15 performs position, estimation processing (steps S5 and S6), The position estimation unit 71 first executes the filtering step based on the unscented Kalman filter using equations (15) to (23) (step S5). In step S5, the position estimation unit 71 estimates a posterior state estimation value of k=0 and a posterior error covariance matrix of k=0 by applying the unscented Kalman filter to the position of the light source 31, the attitude angle of the light source 31, the plurality of illuminance values from the plurality of illuminance sensors, and the light distribution of the light source 31. More specifically, the position estimation unit 71 acquires, from the physical quantity detection unit 40, an observation value Z(0) corresponding to the observation equation based on the position, attitude angle, and light distribution of the light source 31 for k=0 in accordance with equations (12) to (14), The position estimation unit 71 calculates the plurality of o points of a prior state estimation value Xₚ(0) in accordance with equations (15) to (17). A predetermined initial value or the like is preferably used as the prior state estimation value Xₚ(0) used in equation (15).

Next, the position estimation unit 71 calculates yᵢ⁻(k) based on the c points of the prior state estimation value Xₚ(0), calculates a prior output estimation value by unscented transformation based on the prior output estimation value yᵢ⁻(0) corresponding to each o point and the weight Wᵢ in accordance with equation (18), calculates a prior output error covariance matrix P_{yy}⁻(0) by unscented transformation based on the prior output estimation value yᵢ⁻(0) corresponding to each a point, the prior output estimation value y^{Λ-}(0), and the weight Wᵢ, and calculates a prior state/output error covariance matrix P_{xy}⁻(0) by unscented transformation based on the a point Xᵢ⁻, the prior state estimation value Xₚ(0), the prior output estimation value yᵢ⁻(0) corresponding to each σ point, the prior output estimation value y^{Λ-}(0), and the weight Wᵢ in accordance with equation (20), The position estimation unit 71 calculates a Kalman gain G(0) based on the prior state/output error covariance matrix P_{xy}⁻(0), the prior output error covariance matrix P_{yy}⁻(0), and the observation noise covariance matrix R in accordance with equation (21), and calculates a posterior state estimation value Xₛ(0) based on. the prior state estimation value Xₚ(0), the Kalman gain G(0), the observation value Z(0) obtained from the illuminance sensor 41, and the prior output estimation value y^{Λ-}(k) in accordance with equation (22). The posterior state estimation value Xₚ(0) is output as the estimated position of the two-wheel truck 20 at time k−0. The position estimation unit 71 also calculates a posterior error covariance matrix Pₛ(0) based on a prior error covariance matrix Pₚ(0), the Kalman gain G(0), and the prior state/output error covariance matrix P_{xy}⁻(0) in accordance with equation (23).

After step S5 is performed, the position estimation unit 71 performs the prediction step based on the extended Kalman filter using equations (4) to (7) (step S6). In step S6, the position estimation unit 71 estimates a prior state estimation value and a prior error covariance matrix at time k=1, which indicate the estimated position of the mobile body 20, by applying the extended Kalman filter to the posterior state estimation value and the posterior error covariance matrix at time k=0, which have been calculated in step S5. More specifically, the position estimation unit 71 calculates a prior state estimation value Xₚ(1) at time k−1 based on the posterior state estimation value Xₛ(0) and internal sensor information u(0) at time k=0 in accordance with equation (6). The position estimation unit 71 calculates a matrix F(k) by partially differentiating the function f of equation (1) by the state vector X in accordance with equation (4), calculates the matrix G(k) by partially differentiating the function f of equation (1) by the observation model u in accordance with equation (5), and calculates a prior error covariance matrix Pₚ(1) at time k=1 based on a matrix F(0), the posterior error covariance matrix Pₛ(0), the matrix G(0), and the system noise covariance matrix Q in accordance with equation (7).

After step S6 is performed, the position estimation unit 71 determines whether to end the position estimation processing (step S7). For example, if the user inputs an end instruction via the input device 60 or the like or a predetermined time elapses, the position estimation unit 71 determines to end the position estimation processing. A determination result indicating whether to end the processing may be displayed on the display 50.

If it is determined in step S7 not to end the position estimation processing (NO in step S7), the position estimation unit 71 sets time k to next time k+1 (step S8). Then, steps S2 to S7 are repeated for time K+1.

At time k (k=1 or more), the mobile body control unit 73 executes an input command to the two-wheel truck 20 in step S2 (step S2). At time k (k=1 or more), the mobile body control unit 73 calculates the difference between the position of the mobile body 20 at time k (k=1 or more) and the estimated position of the mobile body 20 at time k−1 on the target trajectory, calculates the driving amounts of the respective movable shafts of the mobile body 20 to correct the calculated difference, and generates a movement command corresponding to the driving amounts of the respective movable shafts. The generated movement command is supplied to the mobile body (two-wheel truck) 20 via the third communication interface 13. The two-wheel truck 20 moves indoors in accordance with the movement command.

After step S2 is performed for time k (k−1 or more), the support body control unit 74 determines whether the posterior error covariance matrix Pₛ at time k−1 is larger than a threshold (step S3). If the posterior error covariance matrix Pa at time k−1 is larger than the threshold, this means that the accuracy of a posterior state estimation value Xₛ(k−1) at time k−1, that is, the accuracy of the estimated position is low. To the contrary, if the posterior error covariance matrix Pₛ is smaller than the threshold, this means that the accuracy of the posterior state estimation value Xₛ(k−1) at time k−1 is high. Note that, the user can set the threshold to an arbitrary value via the input device 60 or the like. A determination result indicating whether the posterior error covariance matrix Pₛ is larger than the threshold may be displayed on the display 50.

Therefore, if it is determined that the posterior error covariance matrix Pₛ is smaller than the threshold (NO in step S3), the support body control unit 74 changes the attitude angle of the light source toward the estimated position, that is, the posterior state estimation value Xₛ(k−1) at time k−1 (step S4). In step S4, the support body control unit 74 calculates the target attitude angle of the light source 31 for emitting light to the estimated position Xₛ (k−1) of the two-wheel truck 20, calculates the driving amounts of the respective movable shafts of the support body 32 to change the current attitude angle to the target attitude angle, and then generates an angle change command corresponding to the driving amounts of the respective movable shafts. The generated angle change command is supplied to the motor 33 via the second communication interface 12. The motor 33 drives the support body 32 in accordance with the angle change command, to move it, thereby moving the light source 31 to the target attitude angle. This emits light from the light source 31 to the estimated position of the two-wheel truck 20. In other words, light from the light source 31 follows the two-wheel truck 20. Thus, even if the two-wheel truck 20 moves away from the light source 31, light from the light source 31 can always be detected satisfactorily by the illuminance sensors 41-n attached to the two-wheel truck 20. Consequently, it is possible to reduce a position estimation error.

On the other hand, if it is determined that the posterior error covariance matrix Pₛ at time k (k=1 or more) is larger than the threshold. (YES in step S3), the support body control unit 74 maintains the attitude angle at the time when, the attitude angle is changed last. If the position estimation accuracy is not good, the attitude angle at the time when the position estimation accuracy is good is maintained. Therefore, it is possible to prevent the position estimation error from degrading.

For example, if the light source 31 faces vertically downward (ϕ=−n/2), the spatial distribution of the illuminance of light generated from the light source 31 is concentrically symmetric on the xy plane, thereby degrading the discrimination capability of the position of the two-wheel truck 20. By maintaining the attitude angle, as described, above, it is possible to prevent the attitude angle from being changed to those at which an estimation error degrades.

If it is determined in step S3 for time k (k=1 or more) that the posterior error covariance matrix Pₛ(k−1) is larger than the threshold (YES in step S3), or if step S4 is performed, the position estimation unit 71 executes the filtering step based on the unscented Kalman filter using equations (15) to (23) (step S5) to calculate the posterior state estimation value Xₛ(k) and the posterior error covariance matrix Pₛ(k) at time k, The method of calculating the posterior state estimation value Xₛ(k) and the posterior error covariance matrix Pₛ(k) at time k is the same as that in step S5 at time k=0, and a description thereof will be omitted. The posterior state estimation value Xₛ(k) and the posterior error covariance matrix Pₛ(k) may be displayed on the display 50.

After step S5 is performed, the position estimation unit 71 executes the prediction step based on the extended Kalman filter using equations (4) to (7) (step S6) to calculate the prior state estimation value Xₚ(k+1) and the prior error covariance matrix Pₚ(k+1) at time k+1. The method of calculating the prior state estimation value Xₚ(k+1) and the prior error covariance matrix Pₚ(k+1) at time k+1 is the same as that in step S6 at time k=0, and a description thereof will be omitted. The prior state estimation value Xₚ(k+1) and the prior error covariance matrix Pₚ(k+1) may be displayed on the display 50.

After step S6 is performed, the position estimation unit 71 determines whether to end the position estimation processing (step S7).

If it is determined in step S7 not to end the position estimation processing (NO in step S7), the position estimation unit 71 sets time k to next time k+1 (step S8). Then, steps S2 to S7 are repeated for time k+1.

If it is determined in step S7 to end the position estimation processing (YES in step S7), the processor 15 ends the position estimation processing of the two-wheel truck 20.

Note that the above-described processing procedure is merely an example, and various changes can be made. For example, the attitude angle of the energy source 31 need not always be changed, as will be described below. In addition, although none of steps S3 and S4 are executed at the initial time, none of steps S3 and S4 may be executed for a while from the initial time.

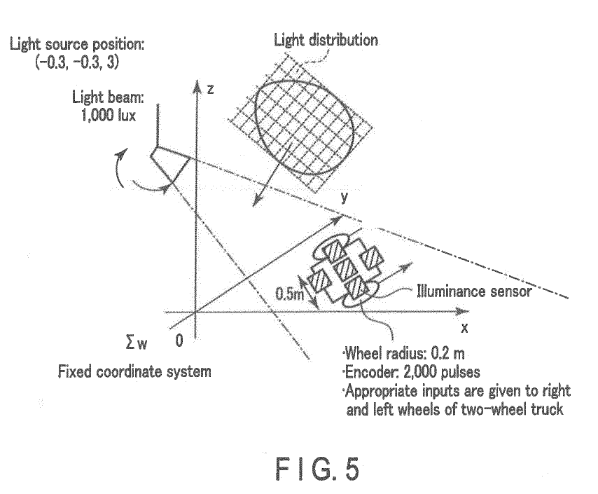

Next, the validity of the position estimation processing according to this embodiment will be verified by simulation, FIG. 5 is a view schematically showing the first simulation conditions. The first simulation conditions are as follows. Assume that, when the mobile body 20 is placed at a base, the position and attitude shift to some extent, and the initial value of the position of the mobile body 20 shifts from the initial value of the estimation algorithm.

<First Simulation Conditions>

wheel radius r of two-wheel truck 20=0.2m

width d of two-wheel truck 20=0.5 m

position (x, y, z) of light source 31=(−0.3, −0.3, 3)

light distribution of light source 31: appropriate distribution

light bears of light source 31=1,000 lux

number of illuminance sensors 41 on two-wheel truck 20=5

positions si of illuminance sensors 41 on two-wheel truck 20: s0=(0, 0, 0), s1=(0.25, 0, 0.1), s2=(0, 0.25, 0.15), s3=(−0.25, 0, 0.2), s4=(0, −0.25, 0.05)

error of illuminance sensors 41=5-lux standard deviation

encoder resolution of two-wheel truck 20=2,000 pulses

encoder error standard deviation=Gaussian distribution approximation of triangular distribution by resolution

initial value (x, y, ϕ, r) of two-wheel truck 20=(0.01, 0.01, 0.05, 0.2)

initial value (x, y, ϕ, r) of prior state estimation value=(0, 0, 0, 0.2+0.03)

encoder change amount uᵣ(k) at sampling interval of right wheel of two-wheel truck 20 and encoder change amount u₁(k) at sampling interval of left wheel of two-wheel truck 20 are input in accordance with equation (24) below when time t satisfies 0<t<4 and equation (25) below when time t satisfies 4<t<8.

uₗ=1/10³, uᵣ=3/10³(0<t<4) (24)

uᵣ₌3/10³, uᵣ=1/10⁸(4<t<8) (25)

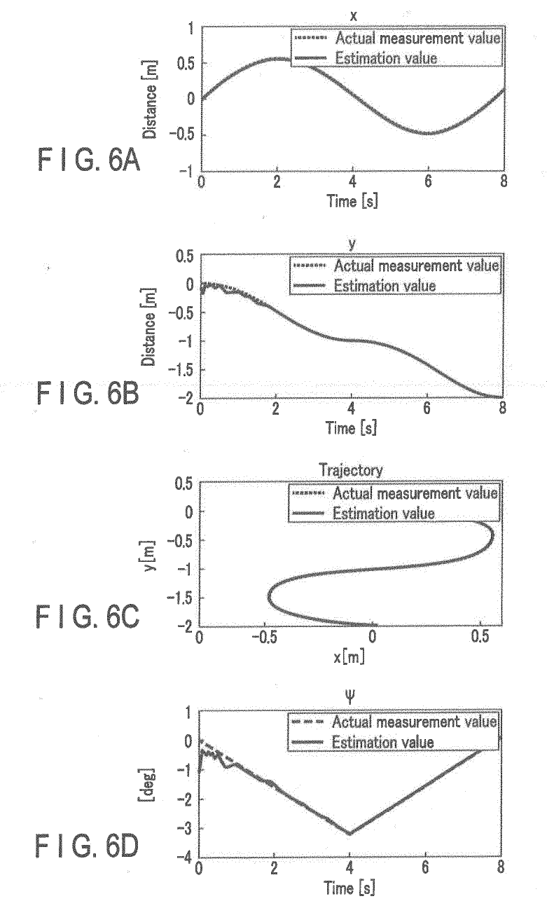

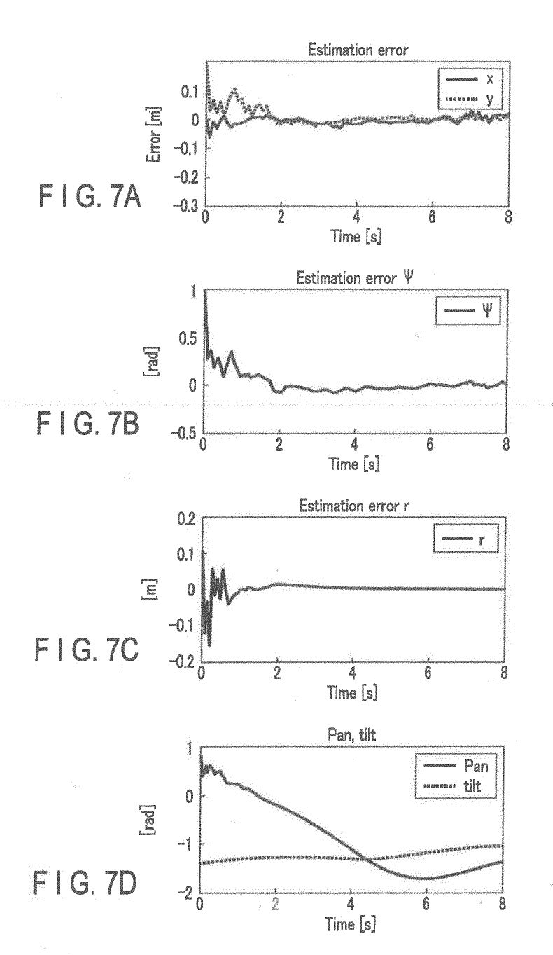

FIG. 6A-D shows views of the simulation result of the estimated trajectory of the two-wheel truck 20, which is obtained by executing the position estimation processing according to this embodiment under the first simulation conditions, FIG. SA shows the time transition of the x-axis coordinate of the two-wheel truck 20, FIG. SB shows the time transition of the y-axis coordinate of the two-wheel truck 20, FIG. SC shows the trajectory of the two-wheel truck 20 on the xy plane, and FIG. 6D shows the time transition of the attitude ψ of the two-wheel truck 20, FIG. A-D shows views of the simulation result of the estimation error of the two-wheel truck 20, which is obtained by executing the position estimation processing according to this embodiment under the first simulation conditions. FIG. 7A shows the time transition of the estimation errors of the x-axis coordinate and y-axis coordinate of the two-wheel truck 20, FIG. 7B shows the time transition of the estimation error of the attitude ψ of the two-wheel truck 20, FIG. 7C shows the time transition of the estimation error of the wheel radius r of the two-wheel truck 20, and FIG. 7D shows the time transitions of the pan angle and tilt angle of the two-wheel truck 20. As shown in FIG. 7A-D, it is understood that after a sufficient time of 2 sec elapses, the position errors with respect to the x- and y-axes are suppressed to 0.02 m or less, and the attitude and wheel, radius can be estimated with, sufficient accuracy. In addition, it is understood that the pan angle and tilt angle of the light source 31 operate appropriately.

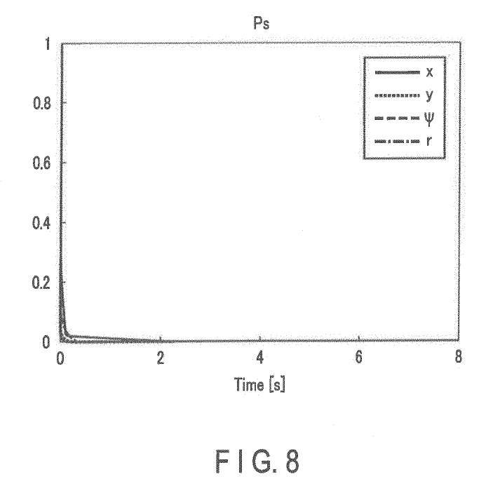

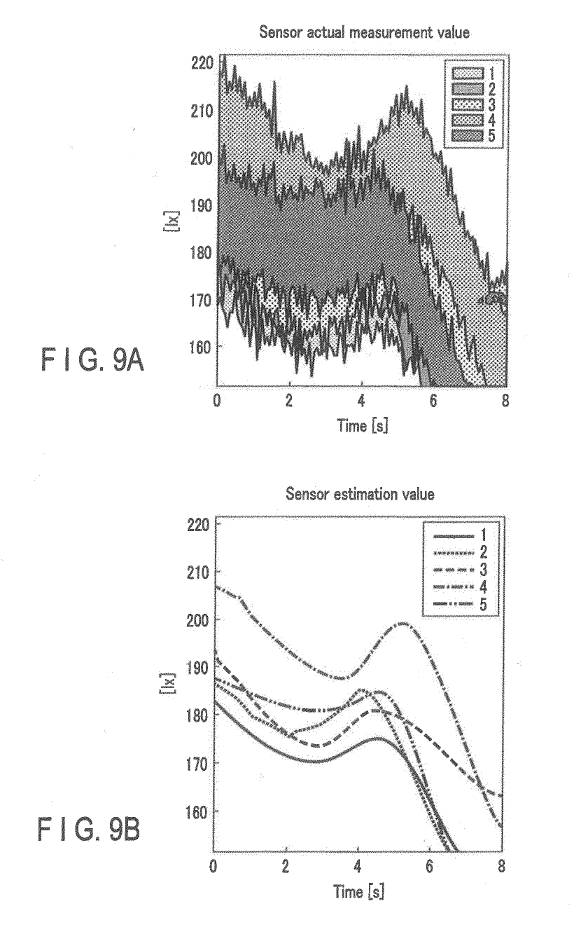

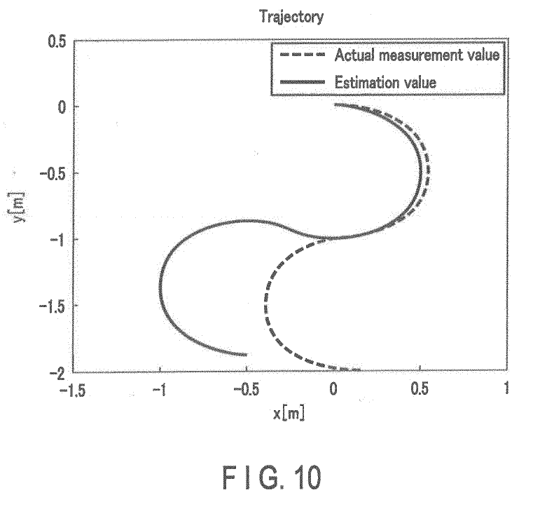

FIG. 8 is a timing chart showing the time-series transitions of diagonal components x, y, ψ, and r of the posterior error covariance matrix Pₛ, which are obtained by executing the position estimation processing according to this embodiment under the first simulation conditions. In FIG. 8, the ordinate represents the values of the diagonal components, and the accuracy is higher as the value is closer to 0, and is lower as the value is closer to 1. In FIG. 8, the abscissa represents the time. As shown in FIG. 8, the diagonal components of the posterior error covariance matrix have sufficiently small values and it is apparent that estimation advances satisfactorily. FIG. 9 shows views of the actual measurement values and estimation values of the respective illuminance sensors 41-n (n=1 to 5), which are obtained by executing the position estimation processing according to this embodiment under the first simulation conditions. In FIG. 9A-B, the ordinate represents the illuminance [1x] and the abscissa represents the time [s] . FIG. 9A shows the time transitions of the actual measurement values, FIG. 9B shows the time transitions of the estimation values. As shown in FIG. 9A-B, it is apparent that noise can be satisfactorily removed. FIG. 10 shows the estimation result of odometry, which is obtained by executing the position estimation, processing according to this embodiment under the first simulation conditions. In FIG. 10, the ordinate represents the y-axis and the abscissa represents the x-axis. As shown in FIG. 10, it is apparent that the estimation error is accumulated with time, thereby deteriorating the estimation accuracy.

As shown in FIGS. 6, 7, 8, and 10, the validity of the position, estimation processing according to this embodiment is verified.

The smallest number of mobile bodies 20 according to this embodiment will be verified next. If the position estimation processing according to this embodiment is applied to the mobile body 20 moving in the three--dimensional space, at least three physical quantity detectors 41 are necessary to grasp a position in the space in consideration of the relative position between the mobile body 20 and the attachment position of the energy source 31. A simulation result when the three illuminance sensors 41 are used will be described below. This simulation is performed under the second simulation conditions. In the second simulation conditions, the positions si of the illuminance sensors 41 on the mobile body 20 are s0=(0, 0, 0), s1=(0.25, 0, 0), and s2=(0, 0.25, 0). The remaining conditions of the second simulation conditions are the same as those of the first simulation conditions.

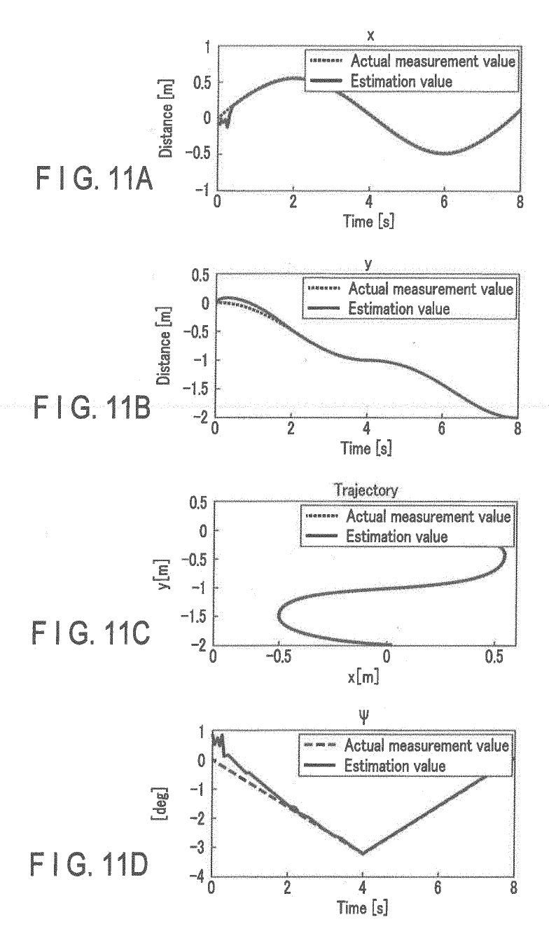

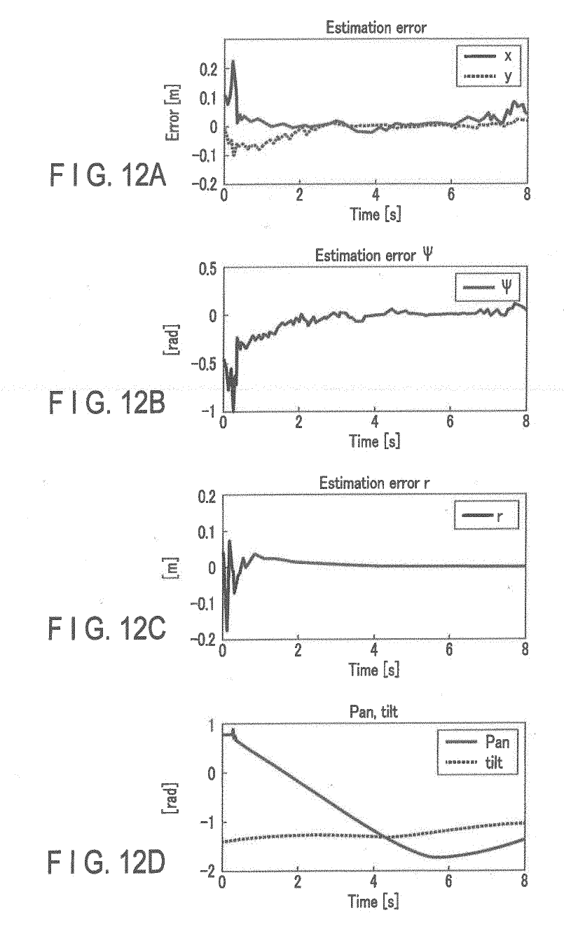

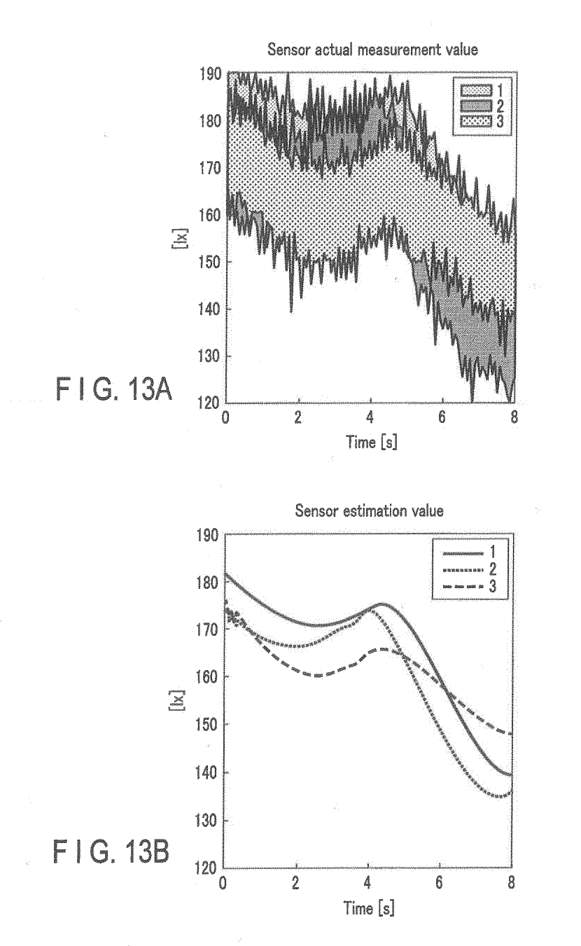

FIG. 11A-D shows views of the simulation, result of the estimated trajectory of the two--wheel truck 20, which is obtained by executing the position estimation processing according to this embodiment under the second simulation conditions, FIG. 12A-D shows views of the simulation result of the estimation error of the two-wheel truck 20, which is obtained by executing the position estimation processing according to this embodiment under the second simulation conditions. As will be apparent by comparing FIGS. 11 and 12 with FIGS. 6 and 7, the estimation error of the y-coordinate in the second simulation increases by about 0.07 m, as compared with the first simulation, but sufficient estimation is performed, FIG. 13A shows views of the actual measurement values of the respective illuminance sensors 41, which are obtained by executing the position estimation processing according to this embodiment under the second simulation conditions. FIG. 13B shows views of the estimation values of the respective illuminance sensors 41, which are obtained by executing the position estimation processing according to this embodiment under the second simulation conditions. As will be apparent by comparing FIG. 13 with FIG. 9, noise can be removed satisfactorily in the second simulation, similarly to the first simulation.

A method of improving the accuracy of the position estimation processing according to this embodiment will be described next.

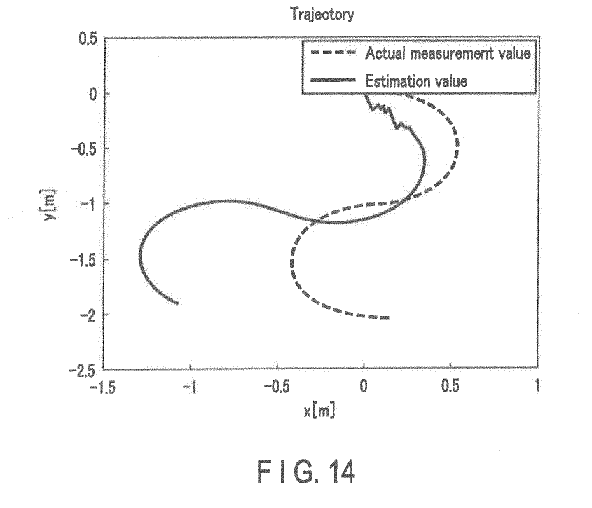

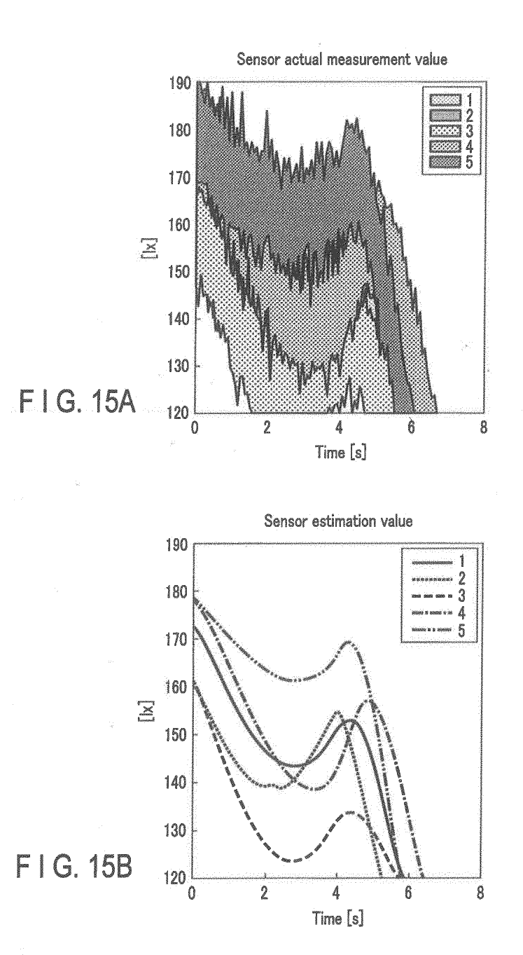

FIG. 14 is a view showing the estimation result of the trajectory of the mobile body 20 when the attitude angle of the energy source 31 is desirably fixed in the vertically downward direction under the second simulation conditions. FIG. 15A shows views of the true actual measurement values of the respective illuminance sensors under the second simulation conditions of FIG. 14. FIG. 15B shows views of the estimation values of the respective illuminance sensors under the second simulation conditions of FIG. 14. As shown in FIG. 14, there is a gap between the true trajectory and estimated trajectory of the mobile body 20. This phenomenon does not occur so often but this indicates that an estimation error may occur.

On the true mobile body trajectory and estimated mobile body trajectory shown in FIG. 14, the actual measurement values of the respective illuminance sensors match each other, as shown, in FIG. 15A-D. This is because if the light source is directed vertically downward, the light source distributions are the same concentrically, and discrimination is impossible. That is, this means that the position cannot be specified based on only the actual measurement values. To the contrary, in an angle range within which the attitude angle of the light source is diagonal, the light distribution of the light source is an elliptic distribution, and thus the operation (step S2) of the attitude angle in the processing procedure of FIG. 4 may be skipped.

The above-described estimation error occurs when the light source emits light vertically downward. Even in the proposed method, if the mobile body 20 enters a region near a position immediately under the energy source, an estimation error may occur. A solution will be described below.

First solution: The attitude angle of the energy source 31 is limited to an angle range (to be referred to as an allowable angle range hereinafter) other than an angle range (to be referred to as a prohibited angle range hereinafter) including a vertical angle. In other words, the light source 31 is not directed in a direction close to the vertically downward direction. A component of the attitude angle contributing to the vertical direction is the tilt angle ϕ. More specifically, if it is determined in step 32 that the posterior error covariance matrix Pₛ(k−1) is not larger than the threshold (NO in step S2), the support body control unit 74 determines whether the posterior state estimation value Xₛ(k−1), that is, the tilt angle ϕ to the estimated position of the mobile body 20 falls within the prohibited angle range or the allowable angle range. If it is determined that the tilt angle ϕ to the estimated position falls within the prohibited angle range, the support body control unit 74 maintains the tilt angle ϕ at time k−1, and advances to step S4. If it is determined that the tilt angle ϕ to the estimated position falls within the allowable angle range, the support body control unit 74 advances to step S3, and supplies, to the motor 33, an angle change command to change the attitude angle of the energy source 31 toward the tilt angle ϕ to the estimated position. The prohibited angle range is determined based on the dispersion characteristics of the physical quantity detectors 41-n and the spatial distribution of the energy emitted from the energy source 31. Note that an arbitrary angle range can be set as the prohibited angle range as long as the central axis A1 of light emitted from the energy source 31 includes 180° parallel to the −2-axis.

The first solution is a good simple solution based on the assumption that the mobile body 20 does not exist near a position immediately under the energy source 31, Considering the use in a warehouse, if the light source 31 is installed on the wall surface, the position immediately under the light source 31 is a position near the wall surface, and there is a low demand to guide the mobile body 20 to the position near the wall surface. Thus, the first solution is regarded as a rational solution.

Second solution; The physical quantity detectors 41-n are attached at different altitudes of the mobile body 20,

Energy generated from the energy source 31 attenuates in accordance with the propagation distance. Thus, even if the mobile body 20 is located immediately under the energy source 31, the values of the physical quantities detected by the respective physical quantity detectors 41-n are different. This makes it possible to more efficiently use space information.

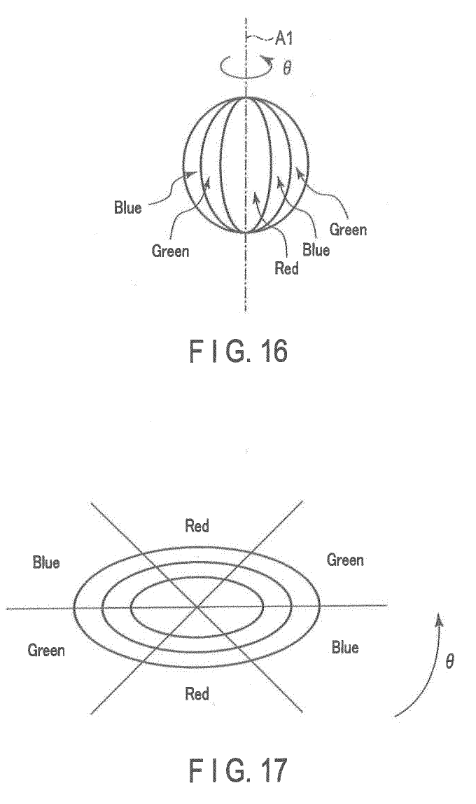

Third solution: If a light source is used as the energy source 31, spectral films (gradation films) are adhered to the light source. FIG. 16 is a view schematically showing the light source to which the spectral films are adhered. FIG. 1 is a view schematically showing the light distribution of light emitted from the light source of FIG. 16 to which the spectral films are adhered. As shown in FIGS, 16 and 17, the illuminance distribution with respect to the direction of the pan angle θ can be changed for each wavelength by sequentially adhering different red, blue, and green films around the pan angle θ. In this case, for example, color sensors corresponding to the spectral films adhered, to the light source are used as the illuminance sensors 41-n attached to the mobile body 20. Each color sensor measures the light intensity at a wavelength corresponding to the color. For example, the color sensors of blue, green, and red can measure the light intensities at wavelengths corresponding to blue, green, and red, respectively. Even if the energy source 31 emits light vertically downward, the direction of the pan angle θ can be identified based on the difference in wavelength. This improves the position estimation accuracy.

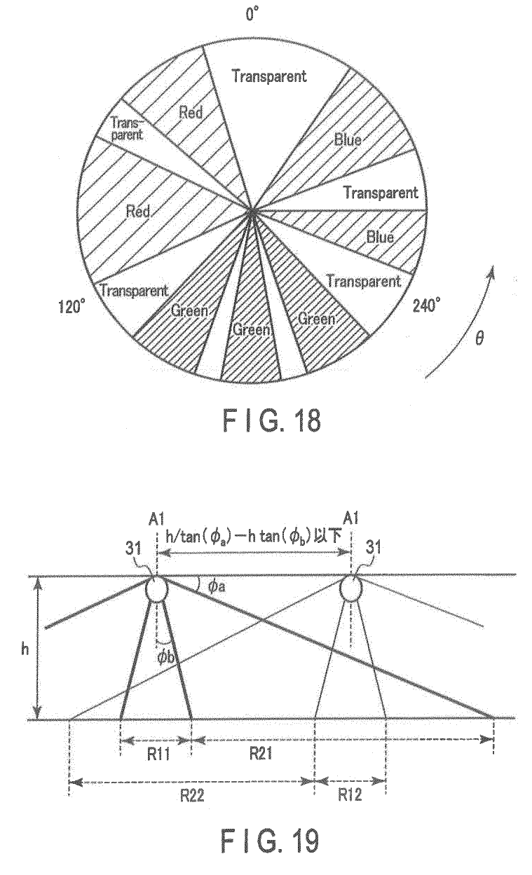

FIG. 18 is a view schematically showing the light source to which the spectral films are adhered in a form different from that shown in FIG. 16. As shown in FIG. 18, the spectral films are adhered to the light source at different angle intervals with respect to the direction of the pan angle θ. For example, the range of 0° to 120° of the pan angle θ is assigned, to red, the range of 120° to 240° is assigned to green, and the range of 240° to 0° is assigned to blue. Instead of adhering the spectral film to the entire pan angle range of each color, a region (transparent) where no spectral, film is adhered is preferably provided, as shown in FIG. 18. An angle range of a transparent region is preferably provided randomly. By providing a transparent region, randomly, as described above, the position identification capability with respect to the direction of the pan angle θ is further improved, and the position estimation accuracy of the mobile body 20 in the state in which the energy source 31 faces vertically downward is further improved. If the attachment height of the light source 31 or the small mobile body 20 is high, the adherence intervals between the blue, green, and red films are preferably narrowed. This prevents the plurality of color sensors attached to the mobile body 20 from falling within the same spectral film angle range, thereby making it possible to further improve the position estimation accuracy.

Fourth solution; Two or more energy sources 31 are used. In this case, the plurality of energy sources 31 are arranged so that an energy irradiation range corresponding to the prohibited angle range of one energy source 31 falls within an energy irradiation range corresponding to the prohibited angle range of another energy source 31.

FIG. 19 is a view showing the arrangement of the two energy sources 31, In FIG. 19, ϕa represents the upper limit of the tilt angle, and ϕb represents the lower limit of the tilt angle, A height h indicates the installation height of the two energy sources 31 from the floor surface. As shown in FIG. 19, by providing the two energy sources 31, the tilt -restriction angle ϕb of one energy source 31 can be compensated for by the other energy source 31. The distance between the first and second energy sources 31 is set so that a prohibited angle range E11 of the first energy source 31 is included in an allowable angle range R22 of the second energy source 31 and a prohibited angle range R12 of the second energy source 31 is included in an allowable angle range R21 of the first energy source 31. More specifically, the interval between the two energy sources 31 is set to h/(tan(ϕa))-h.tan(ϕb) or less. This method increases the number of energy sources 31 but can eliminate an estimation error area. In this case, since each of the two or more energy sources 31 emits energy to the mobile body 20, it is desirable to separately measure energy from each energy source 31.

If light sources are used as the energy sources 31, a wavelength is changed for each light source using spectral films and the like. For example, a red film is adhered to the first light source 31, and a blue film is adhered to the second light source. As an illuminance sensor attached to the mobile body 20, a sensor capable of detecting an illuminance for each wavelength or a plurality of illuminance sensors for each frequency are preferably prepared.

If parametric loudspeakers are used as the energy sources 31, an output frequency is changed for each sound source. By changing the frequency for each sound source, it is possible to discriminate between sound waves generated by the sound sources. As a physical quantity detector, a microphone for converting a sound pressure into an electrical signal is used. The parametric loudspeaker is described in non-patent literatures 2 and 3.

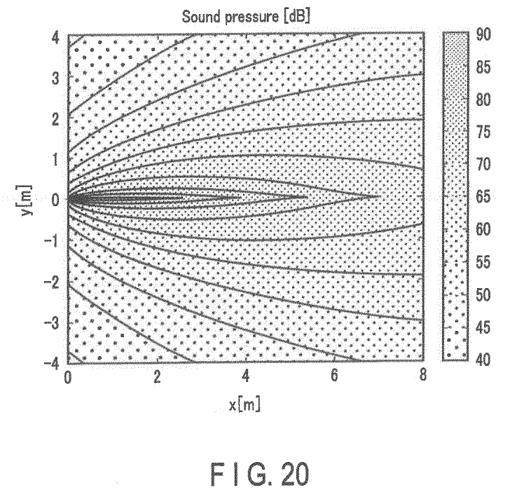

FIG. 20 is a view showing a sound pressure distribution generated from a parametric loudspeaker of an output frequency of 1 kHz in consideration of an end-fire array. As shown in FIG. 20, a sound wave generated from the parametric loudspeaker has sharp directivity and a sound pressure gradient higher than that of the light source, and is thus suitable for position estimation according to this embodiment. Furthermore, since the contribution rate of the influence of environment reflection other than primary reflection is low, and the primary reflection is total reflection, the influence of environment reflection is low in a room environment. Consequently, the ultrasonic wave is appropriately applied to position estimation according to this embodiment from the viewpoint that the microphone picks up no reverberation component.

The third simulation for verifying the validity of the fourth solution when two parametric loudspeakers are used as the energy sources 31 will be described next. The third simulation conditions are as follows. A parametric loudspeaker (PAL1) for outputting 1 kHz and a parametric loudspeaker (PAL2) for outputting 2 kHz are used. The installation positions of the parametric loudspeakers are given by PAL1=(0,3, −0.3, 3.0) and PAL2=(−0.3, —1.7, 3.0). PAL1 is set near a position immediately above the mobile body 20 at the time of the first half of movement, and PAL2 is set near the position immediately above the mobile body 20 at the time of the second half of movement. That is, in this setting, an estimation error may occur when one PAL is used, A microphone noise standard deviation is 0.5 dB. An observation equation is given by equation (26) below.

slᵢⱼ(k)=Pₛ(θₐᵢⱼ(k), rᵢⱼ(k))+nᵢⱼ (26)

Similarly to the case in which the light sources are used, estimation is performed using the extended Kalman filter (Pi represents the sound pressure distribution, of PAL (i=1, 2), j represents the number of the microphone (mic), rij represents a vector from PAL(i) to mic(j), and θaij represents an angle formed by the orientation of PAL and rij). Three microphones are attached to the mobile body 20, and the attachment positions of the microphones are s0=(0, 0, 0.2), s1=(0.25, 0, 0.23), and s2=(0, 0,25, 0.25). Note that the microphones are attached, at different altitudes based on the second solution. The actual measurement values of each microphone are obtained at two frequencies of 1 kHz and 2 kHz. Thus, six actual measurement values in total are obtained. The remaining conditions of the third simulation conditions other than the above conditions are the sane as those of the second simulation conditions.

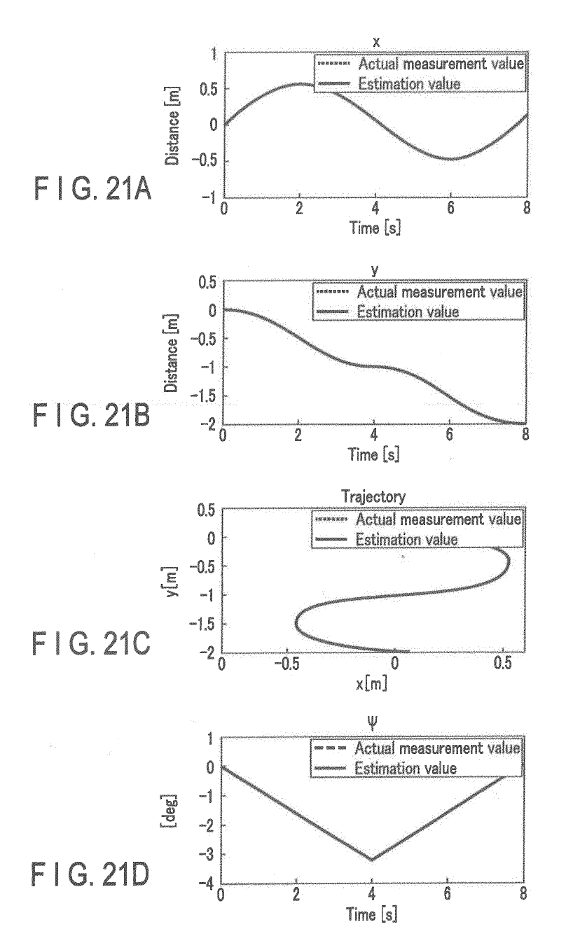

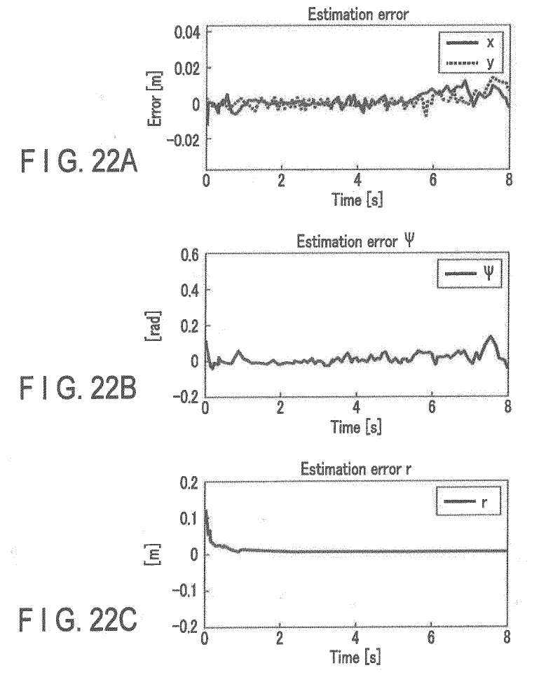

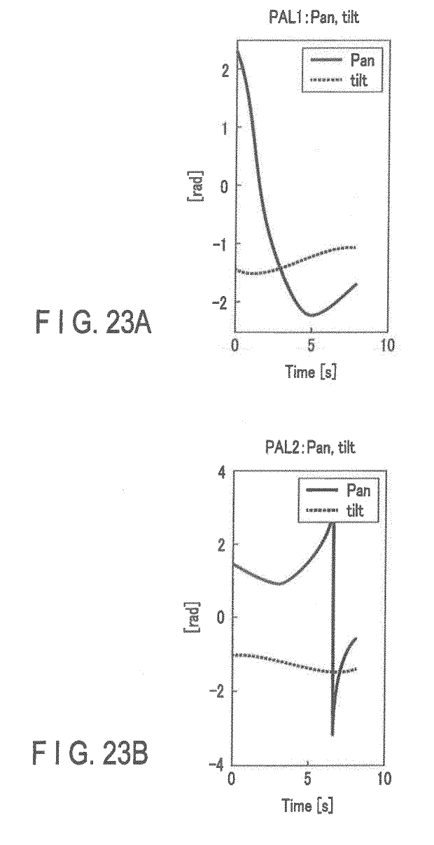

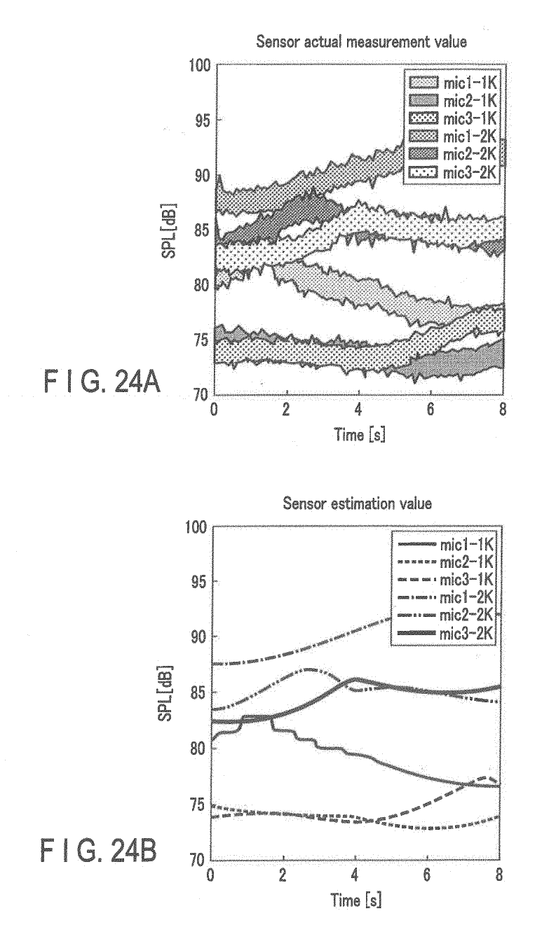

FIG. 21A-D show views of the simulation result of the estimated trajectory of the two-wheel truck 20, which is obtained by executing the position estimation processing according to this embodiment under the third simulation conditions. FIG. 22A-C show views of the simulation result of the estimation error of the two-wheel truck 20, which is obtained by executing the position estimation processing according to this embodiment under the third simulation conditions of FIG. 21. FIG. 23A-B show views of the time transitions of the pan angles and tilt angles of the respective parametric loudspeakers, which are obtained by executing the position estimation processing according to this embodiment under the third simulation conditions of FIG. 21A-B. FIG. 24A shows views of the actual measurement values of the respective illuminance sensors under the simulation conditions of FIG. 21A-D. FIG. 24B shows views of the estimation values of the respective illuminance sensors under the simulation conditions of FIG. 21A-B. In FIG. 24A-B, “1K” and “2K” indicates the system of the first frequency and the system of the second system, respectively. As shown in FIGS. 21A-D and 22A-C, in the third simulation,, sufficient position estimation with a position error of 0.02 m or less is executed. As shown in FIG. 23A-B, high-accuracy estimation is performed even near an area where the light source 31 faces vertically downward. Therefore, the validity of the third solution is confirmed. However, as shown in FIG. 24A-B, with respect to PAL1, the actual measurement values of mic2 and mic3 are similar to each other before 4 sec, and the actual measurement values of mic1 and mic3 are similar to each other after 6 sec. With respect to PAL2, the actual measurement values of mic2 and mic3 are similar to each other after 4 sec. Thus, the estimation accuracy is adversely influenced. In fact, it is apparent that the observation values are substantially four data after 6 sec, and the estimation accuracy degrades to some extent. This is due to the sharp straightness of the parametric loudspeaker. As is apparent from the sound pressure distribution of PAL shown in FIG. 20, the sound pressure gradient is steep on a surface perpendicular to the sound wave advancing direction, and is moderate in the advancing direction. Therefore, even if the attitude of PAL is inclined, microphones 2 and 3 installed at equal distances from the center of the mobile body 20 on the xy plane tend to measure similar sound pressure values near the sound source.

A solution for the above problem caused by the symmetry of the arrangement of the microphones 2 and 3 will be described next. This problem is improved by setting different distances as distances from the center of the mobile body 20 to the microphones 2 and 3 on the xy plane and collapsing the symmetry. The fourth simulation is executed by changing the positions of the microphones of the third simulation conditions. The positions of the microphones of the fourth simulation conditions are s0=(0, 0, 0.2), s1=(0.25, 0, 0.23), and s2=(0, 0.25/2, 0.25). The remaining conditions are the same as those of the third simulation conditions.

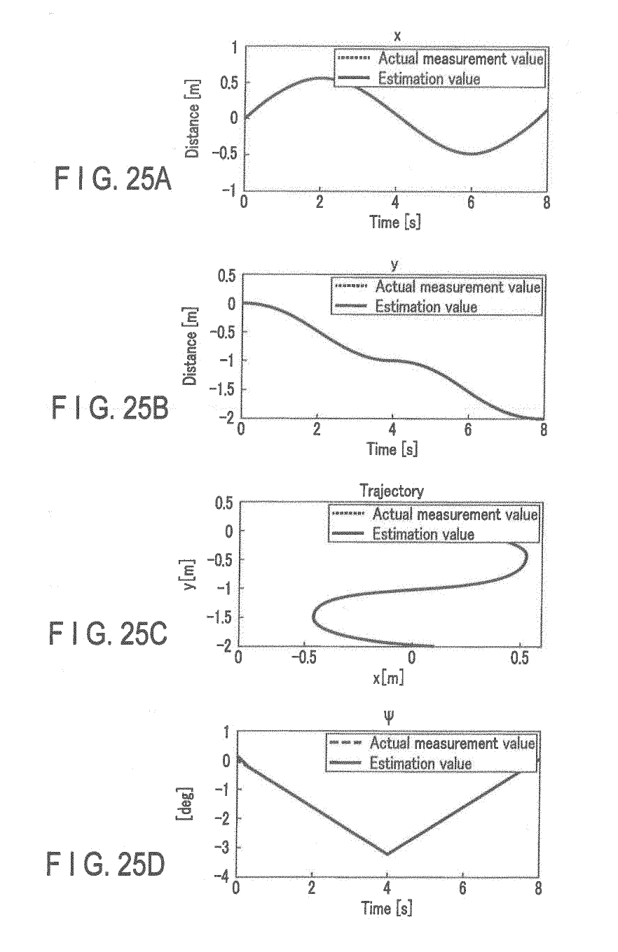

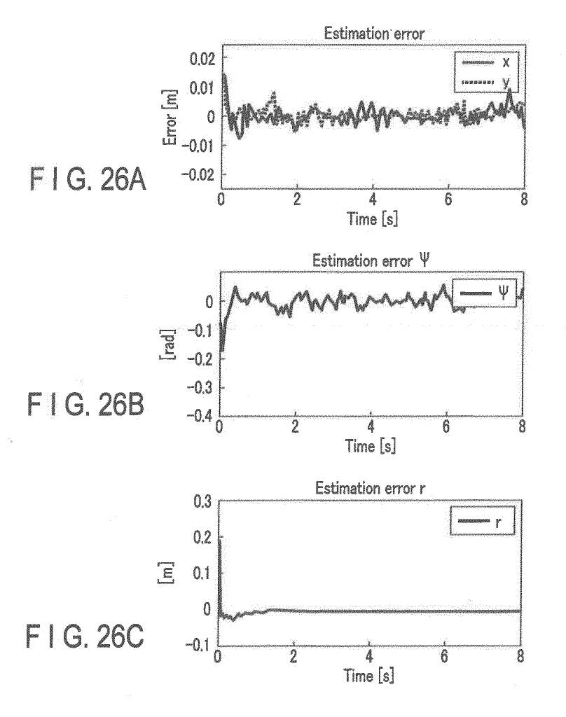

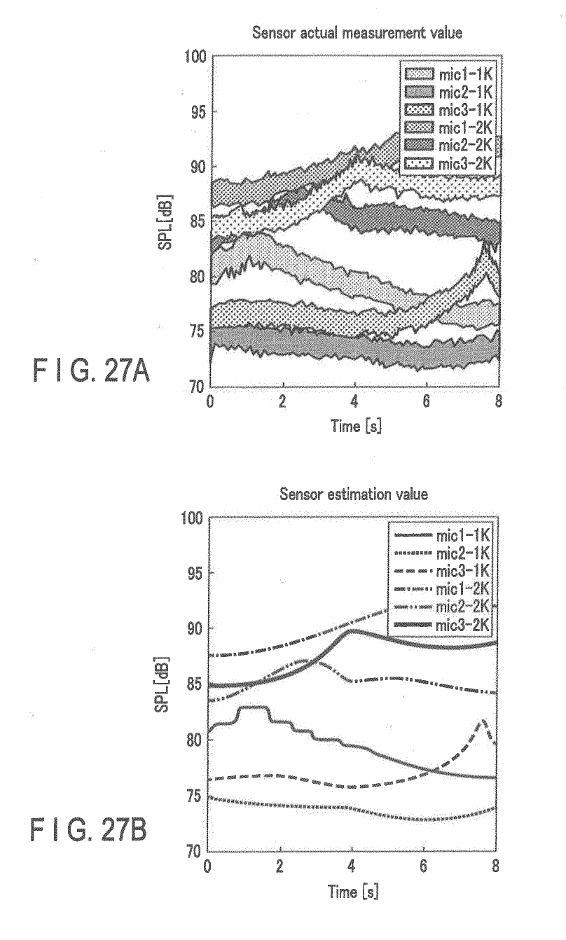

FIG. 25A-D show views of the simulation result of the estimated trajectory of the two-wheel truck 20, which is obtained by executing the position estimation processing according to this embodiment under the fourth simulation conditions. FIG. 26A-C show views of the simulation result of the estimation error of the two-wheel truck 20, which is obtained by executing the position estimation processing according to this embodiment under the fourth simulation conditions of FIG. 25A-D. FIG. 27A-B show views of the actual measurement values and estimation values of the respective illuminance sensors under the fourth simulation conditions of FIG. 25A-D. As shown in FIGS. 25A-D, 26A-C, and 27A-D, the estimation error is 0.01 m or less, and it is thus found that the estimation accuracy is improved in the fourth simulation, as compared with the third simulation, As will be apparent by comparing FIG. 25A-D with FIG. 22A-C, the phenomenon in which the observation values of the microphones are similar to each other is reduced, and the observation values can be effectively reflected on position estimation. It is apparent that the position estimation accuracy is improved by asymmetrically arranging the physical quantity detectors 41 at different distances from the center of the mobile body 20 in consideration of the spatial distribution of energy.

Note that a case in which the position of each energy source 31 is fixed and the number of energy sources 31 is two or less has been explained. However, this embodiment, is not limited to this. Three or more energy sources 31 may be arranged, and the position of each energy source 31 may be variable. In this case, an internal sensor which acquires the correct position of each energy source 31 is preferably provided. The internal sensor acquires the position information of each energy source 31, and transmits it to the processor IS, and then the processor 15 improves the position estimation accuracy of the mobile body 20 by using the position information for the position estimation processing.

As described above, the mobile body position estimation system 1 according to this embodiment includes the energy source 31, the mobile body 20, the plurality of physical quantity detectors 41-n, and the position estimation unit 71. The energy source 31 generates energy whose physical quantity changes in accordance with the propagation distance and directivity.

The mobile body 20 is a position estimation target. Each of the plurality of physical quantity detectors 41-n is provided in the mobile body 20. and repeatedly detects the physical quantity of the energy generated from the energy source 31. The position estimation unit 71 estimates the position of the mobile body 20 based on the position of the energy source 31, the attitude angle of the energy source 31, and the plurality of physical quantity values respectively output from the plurality of physical quantity detectors 41-n.

With the above arrangement, the mobile body position estimation system 1 according to this embodiment includes the energy source 31 for generating energy whose physical quantity changes in accordance with the propagation distance and directivity. Thus, position information as energy is distributed in the entire space where the mobile body 20 exists. Since each of the plurality of physical quantity detectors 41-n detects the energy generated from the energy source 31, the physical quantity values of the plurality of physical quantity detectors 41-n are different in accordance with the positions of the physical quantity detectors 41-n. The position estimation unit 71 can estimate the position of the mobile body 20 by using the position of the energy source 31, the attitude angle of the energy source 31, and the plurality of physical quantity values.

Since, unlike the conventional example, it is not necessary to install a plurality of ultrasonic sensors at an Interval of 1 to 2 m on a ceiling or the like, the mobile body position estimation system 1 according to this embodiment can perform high-accuracy position estimation at low cost. Furthermore, -unlike the conventional example, the mobile body position estimation system 1 according to this embodiment uses neither Wi-Fi radio waves nor an indoor GPS signal, and thus the position estimation accuracy never degrades due to the influence of the indoor multipath of radio waves. There Is known a position estimation method using the arrival time of an ultrasonic wave. However, in this method, it is necessary to synchronize an ultrasonic source and an ultrasonic detector, which tends to cost much. The mobile foody position estimation system 1 according to this embodiment uses the physical quantity of the energy generated from the energy source 31, and it is thus unnecessary to synchronize the energy source 31 and the physical quantity detectors 41-n. The mobile body position estimation system 1 according to this embodiment uses external information which is the energy from the energy source 31, in addition to dead reckoning, and can thus significantly improve the estimation accuracy, as compared with dead reckoning.

According to the above-described embodiment, there are provided a mobile body position estimation system, apparatus, and method which can readily perform high-accuracy position estimation.

While certain embodiments have been described, these embodiments nave been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A mobile body position estimation system comprising;
an energy source configured to generate energy whose physical quantity changes;
a mobile body as a position estimation target;
a plurality of physical quantity detectors each provided in she mobile body and configured to detect the physical quantity of the energy generated from the energy source; and
a processor configured to estimate a position of the mobile body based on a position of the energy source, an attitude angle of the energy source, and a plurality of physical quantity values respectively detected by the plurality of physical quantity detectors.

2. The system of claim 1, further comprising:
a support body configured to variably support the attitude angle of the energy source; and
a motor configured to drive the support body to adjust the attitude angle of the energy source so that the energy is emitted to the estimated position.

3. The system of claim 2, wherein the motor limits the attitude angle of the energy source to an allowable angle range other than a prohibited angle range including a vertical angle.

4. The system of claim 3, wherein
the energy source includes a plurality of sources each configured to generate the energy, and
the plurality of sources are arranged so that an irradiation range of the energy corresponding to the prohibited angle range of one of the plurality of sources is included in an irradiation range of the energy corresponding to the allowable angle range of another one of the plurality of sources.

5. The system of claim 2, wherein the processor calculates a posterior state estimation value and a posterior error covariance matrix as the estimated position by applying an unscented Kalman filter to the position of the energy source, the attitude angle of the energy source, the plurality of physical quantity values, and a spatial distribution of the energy generated by the energy source.

6. The system of claim 5, wherein the processor compares the posterior error covariance matrix with a threshold, and if the posterior error covariance matrix is higher than the threshold, the processor outputs, to the motor, a signal to hold the attitude angle of the energy source, and if the posterior error covariance matrix is lower than the threshold, the processor outputs, to the motor, a signal to change the attitude angle of the energy source toward the posterior state estimation value.

7. The system of claim 1, wherein the number of the plurality of physical quantity detectors is three or more.

8. The system of claim 1, wherein the plurality of physical quantity detectors are attached at different altitudes of the mobile body.

9. The system of claim 1, wherein the plurality of physical quantity detectors are attached at different distances from the center of the mobile body.

10. The system of claim 1, farther comprising:
an azimuth detector attached to the mobile body,
wherein the processor estimates the estimated position based on an azimuth detection value output from the azimuth detector in addition to the position of the energy source, the attitude angle of the energy source, and the plurality of physical quantity values.

11. The system of claim 1, wherein, the processor estimates the estimated position using at least one algorithm among a Kalman filter, an extended Kalman filter, an unscented Kalman filter, and a particle filter based on a movement model of the mobile body and at least one of pieces of internal information, of a rotation angle, acceleration, and angular velocity of the mobile body in addition to the position of the energy source, the attitude angle of the energy source, and the plurality of physical quantity values.

12. The system of claim 1, wherein the energy source is one of a light source configured to generate light as the energy and a parametric loudspeaker configured to generate a sound wave.

13. The system of claim 1, wherein the energy source is a light source to which spectral films are adhered to change an illuminance distribution for each wavelength.

14. The system of claim 1, wherein
the energy source includes a plurality of light sources each configured to generate a light beam as the energy, and
different spectral films are attached to the plurality of light sources to discriminate between the generated light beams.

15. The system of claim 1, wherein
the energy source includes a plurality of parametric loudspeakers each configured to generate a sound wave as the energy, and
the plurality of parametric loudspeakers generate sound waves belonging to different frequency bands so as to discriminate between the generated sound waves.

16. A mobile body position estimation apparatus comprising:
an input device provided in a mobile body as a position estimation target and configured to input a plurality of physical quantity values respectively detected by a plurality of physical quantity detectors each configured to detect a physical quantity of energy generated from an energy source; and
a processor configured to estimate a position of the mobile body based on a position of the energy source, an attitude angle of the energy source, and the plurality of physical quantity values.

17. A mobile body position estimation method comprising:
generating, from an energy source, energy whose physical quantity changes;
detecting, by a plurality of physical quantity detectors each provided in a mobile body as a position estimation target, the physical quantity of the energy generated, from the energy source; and
estimating a position of the mobile body based on a position of the energy source, an attitude angle of the energy source, and a plurality of physical quantity values respectively detected by the plurality of physical quantity detectors.
